(19) United States
(12) Patent Application Publication
(10) Pub. No.: US 2006/0011504 A1
(43) Pub. Date: Jan. 19, 2006

(54) Object provided with an individual characterizing system enabling its identification, and methods and devices for characterizing and identifying objects, in particular packages, labels or the like

(75) Inventors: Harald Gosebruch, Verden (DE); Matthias Overath, Hamburg (DE); Wolgang Drabner, Wohtorf (DE); Gottfried Von Bismarck, Hamburg (DE)

Correspondence Address: VENABLE LLP, P.O. BOX 34385, WASHINGTON, DC, 20045-9998, US

(73) Assignee: Hauni Maschinenbau AG, Hamburg (DE)

(21) Appl. No.: 10/534,425

(22) PCT Filed: Nov. 12, 2003
(86) PCT No.: PCT/EP03/12653

§ 371 Date: May 10, 2005

(30) Foreign Application Priority Data
Nov. 12, 2002 (EP) 02090376.1

(51) Int. Cl. B65D 85/00; G06K 9/00; G06F 17/00

(52) U.S. Cl. 206/459.5; 235/375; 382/103

(57) ABSTRACT

The invention concerns an article, in particular a packaging, which is provided with an individual marking means. Furthermore, the invention concerns methods and devices for the individual marking and identification of articles, in particular packages. Known packagings have marking means which of course confer a certain degree of safety from counterfeiting. But firstly the packagings are expensive to make due to the additional marking elements. Secondly the usual marking means can also be manipulated with corresponding expenditure, so that a large number of counterfeit packagings are still in circulation. Due to the packaging according to the invention, which is characterised in that the marking means is a random identifier peculiar to the article, in particular to the package, the safety from counterfeiting is increased compared with conventional packagings, this being with very little expenditure, so that the costs of the packaging are also lower than known packagings. The methods and devices for marking and identification are accordingly also simple, favourable and reliable.

The invention concerns an article which is provided with an individual marking/labelling means for identification. Furthermore, the invention concerns methods for the individual marking of articles, in particular packaging, with an individual marking means, as well as for the identification of articles, in particular packaging, provided with an individual marking means, by detection and evaluation of the marking means. The invention further concerns devices for the individual marking of articles, in particular packaging, with an individual marking means, as well as for the identification of articles, in particular packaging, with an individual marking means.

Articles, in particular packagings, are frequently provided with an individual marking means. The marking means serves in particular for identification of the article or packaging for authenticity and origin. Identification is in many cases important in order to be able e.g. firstly to detect counterfeit goods or counterfeit products in original packaging and secondly to monitor marketing routes. The marking and identification of packagings are of especial importance in many different fields. In particular in the cigarette industry as well as the pharmaceutical and cosmetic industries, counterfeiting leads to considerable financial losses for the manufacturing companies and in certain circumstances even a risk to the health of consumers.

It is therefore known and normal to provide packaging with various marking or security systems, to allow identification and hence association with the authorised manufacturer or monitoring of marketing routes. Marking can be done for example by applying a code to the packaging. The code can e.g. consist of coded or uncoded elements, e.g. numbers, letters or other elements. Bar codes, holograms and storage media, e.g. magnetic strips, memory chips or the like, are only some of the known possible ways of marking.

However, all previous packaging as well as methods and devices for the marking and identification of packaging have in common the disadvantage that firstly they are expensive to manufacture and handle, and secondly they do not offer sufficient security against imitation. Unambiguous and unequivocal marking or identification is not possible. Packaging whose original source cannot be proven can easily be put into circulation, as the known methods and devices can be manipulated by bypassing, imitating or counterfeiting marking, e.g. bar codes. All known packagings are labelled by applying marking means which are usually defined previously. Hence, firstly the expenditure on marking is high, which with an increasing degree of security leads to rising costs in manufacture. Secondly, considerable expenditure is also required for identification.

It is therefore the object of the present invention to propose an article which is easy to label and identify and particularly safe from counterfeiting. Furthermore, it is the object of the invention to propose methods for the marking and identification of articles, in particular packages, which are easy and cheap and guarantee particularly high safety from counterfeiting. It is a further object of the invention to provide devices for the marking and identification of articles, in particular packages, which are cheap, easy to handle and reliable.

The object is achieved firstly by an article of the kind mentioned hereinbefore by the fact that the marking means is a random identifier peculiar to the article. Preferably, the article is a package. As a result, the safety from counterfeiting compared with known packaging is increased, as random identifiers firstly are more difficult to imitate or counterfeit than predefined identifiers. Secondly, due to the fact that the random identifier is peculiar to the respective packaging, there is provided a marking means which is particularly effective and unambiguous and already present on the packaging. Due to manufacture, no packaging is like another, so that without extra effort, simply due to actual manufacture of the packaging, a marking means which is random and unique and so particularly difficult to counterfeit is provided. In other words, every packaging is its own individual marking means.

In an advantageous development of the invention, the random identifier forms part of the design of the packaging. Unlike known marking means which are selected before application or attachment to the packaging, the random identifier according to the invention is produced only by forming the packaging itself, so that there is particularly effective safety from counterfeiting. Unlike, for example, labels to be applied to the packaging, which can be copied and applied to counterfeit packaging, the random identifier as part of the design of the packaging is not predictable by anyone and so cannot be copied either.

Advantageously, the random identifier is composed of at least one random pattern, the random pattern being composed of a distribution of luminophores. This technological obstacle to counterfeiting allows marking and identification of the packaging which is reliable and particularly easy to attach, apply and/or introduce randomly, and which is therefore very safe from counterfeiting and easy to read, particularly machine-readable. This design of the packaging has the particular advantage that the random identifier is invisible under normal conditions and can be made visible only by a special treatment, as a result of which there is an extra obstacle in counterfeiting. Moreover, a visual impairment of the packaging can therefore be dispensed with.

In a further preferred embodiment of the packaging according to the invention, in addition to the random pattern a marking generated from the random pattern is arranged on the packaging. As a result, firstly an even greater level of security is reached, as marking of the packaging is composed of different elements. Secondly, due to association of the random pattern with the marking, identification is made easier because alignment or identification can be done without a data bank.

Particularly advantageous is a design of the packaging in which, in addition to the random pattern and/or marking, the packaging is provided with a coding means, in particular a serial number. Due to the additional serial number, an even higher level of security is obtained because random pattern, marking and serial number can be combined into an individual data record which can be decoded and so imitated only with great difficulty.

Preferably, the random identifier is an integral part of the packaging itself, so that easy manufacture is possible, namely with little expenditure or without any extra expenditure, and the marking system, the recognition and decoding of which are usually necessary for imitation or counterfeiting, cannot readily be seen as marking of the packaging.

In a further preferred embodiment of the packaging, the coding means and/or the marking means and/or the marking are arranged on the primary packaging and/or the secondary packaging and/or the tertiary packaging of the packaging in such a way that they can be clearly identified from the outside. Here, primary packaging means the type of packaging which is directly in contact with the packed products, e.g. blister packs. Secondary packagings are the so-called surrounding packagings or wrappings, e.g. folded boxes. Tertiary packagings means surrounding cartons, dispatch cartons, pallets or the like. By optional attachment/application/introduction of the labels, coding means, markings, etc. to one or more of the aforementioned types of packing, for example so-called “repacking” is protected, as association of the individual types of packaging with each other is clearly ensured.

The object is further achieved by a method for the individual marking of articles, in particular packages, by the steps of: detection of a random identifier peculiar to the article, in particular to the packaging, as a marking means, conversion of the random identifier to an individual marking and filing of the marking as a data record in a data bank and/or as print on the article, in particular on the packaging. As a result, in a surprisingly simple and effective manner reliable marking of packaging is obtained, as the application of any security means, e.g. labels, magnetic strips or the like, is dispensable. Marking includes, to put it simply, merely the incorporation of identifiers which are already present on the packaging and which must also be converted to a marking for later identification and filed in a simple form.

In a particularly preferred embodiment, the packaging is provided with a random identifier peculiar to the packaging, preferably a random pattern consisting of luminophores, as a marking means. This firstly has the advantage that the random identifier is not readily recognisable. Secondly, detection and identification are possible with high precision, so that particularly high safety from counterfeiting and identification quota are achieved. Furthermore, there is also a reduction in expenditure on identification, which particularly facilitates handling.

The object is further achieved by a method for the identification of articles, in particular packages, provided with an individual marking means, by the steps of: detection of a random identifier peculiar to the article, in particular to the packaging, as a marking means, conversion of the random identifier to an individual marking and alignment of the marking with print of the marking on the article, in particular on the packaging, and/or with a data record filed in a data bank and containing the marking. As a result, reliable and secure recognition of original packaging is ensured.

A device for the individual marking of articles, in particular packages, with an individual marking means which is characterised in that a means is provided for detecting at least one random identifier peculiar to the article, in particular to the packaging, as a marking means, a means for generating and displaying or outputting a marking from the random identifier, and a means for filing the marking, likewise achieves the object.

Furthermore, the object is achieved by a device for the identification of packagings provided with an individual marking means, which is characterised in that a means is provided for detecting at least one random identifier peculiar to the packaging as a marking means, and a means for generating and displaying or outputting a marking from the random identifier.

Further preferred embodiments of the packaging and of the devices as well as advantageous steps of the method are apparent from the subsidiary claims and the description. Particularly preferred examples are described in more detail with the aid of the attached drawings. The drawings show:

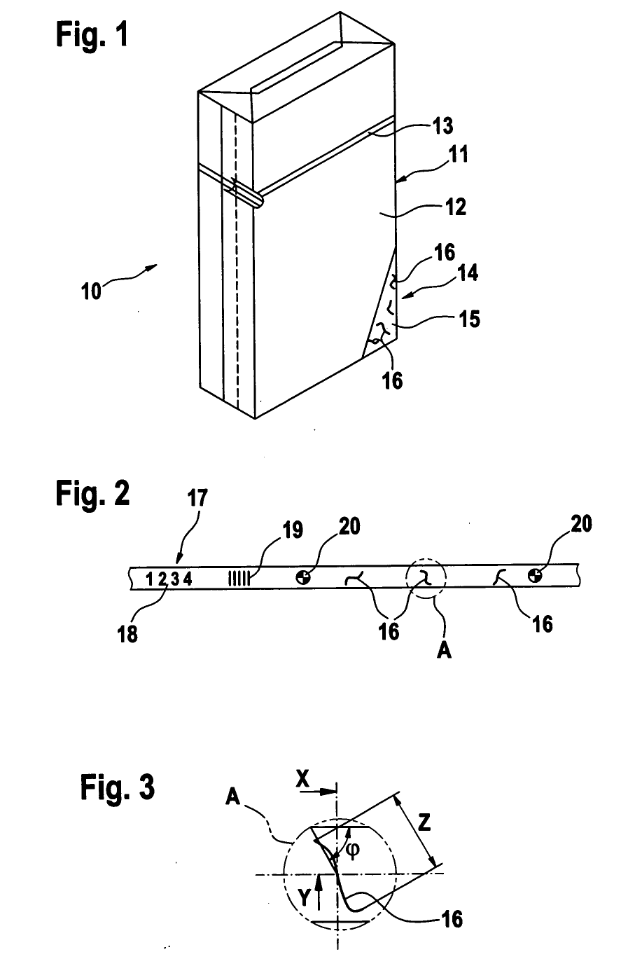

FIG. 1 a perspective view of a packaging with a folded box and a wrapping, namely a cigarette packet with a film wrapping, wherein the random identifier is designed in a portion of the packaging,

FIG. 2 a tear strip of the wrapping shown in FIG. 1 with a serial number, a bar marking, reference or measurement marks, and a random pattern,

FIG. 3 the detail A in FIG. 2 on a much larger scale,

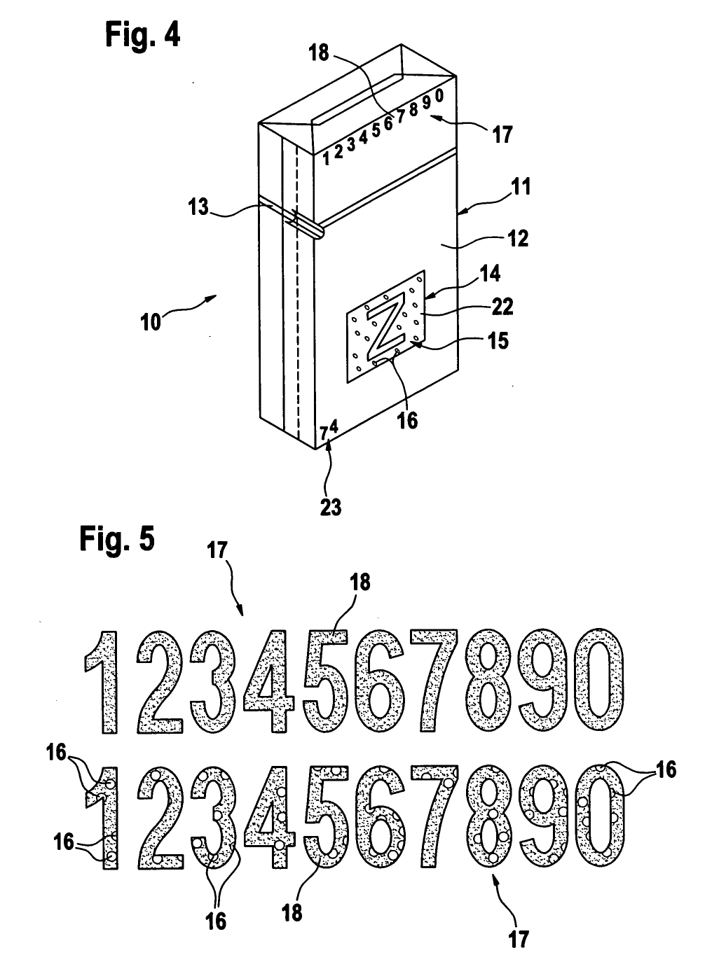

FIG. 4 a perspective view of a packaging with a further design of a random pattern and a serial number,

FIG. 5 a view of a further design of a random pattern,

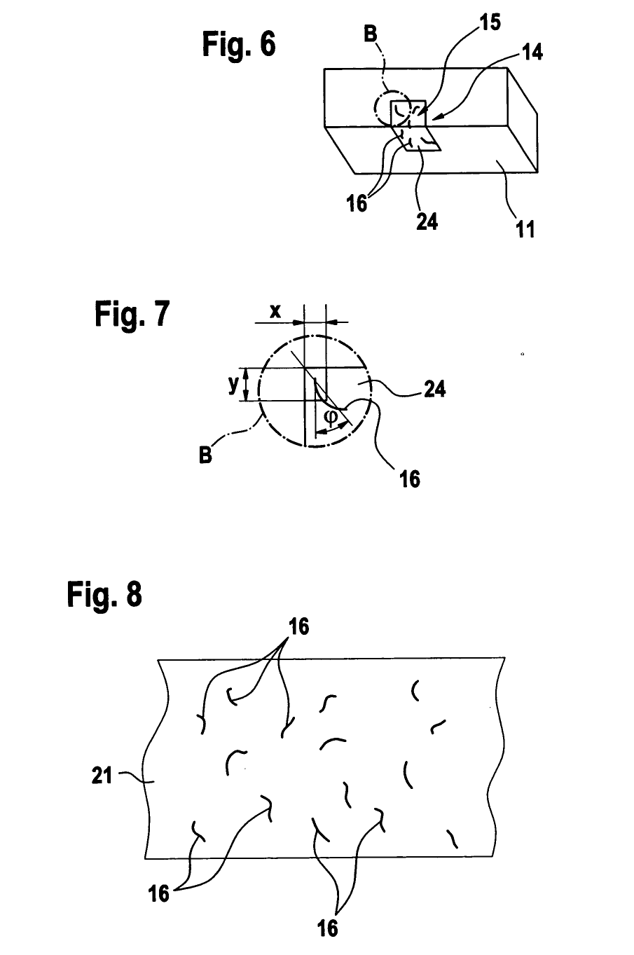

FIG. 6 a perspective view of a packaging portion with a tax stamp or the like, wherein the tax stamp constitutes a further design of the random pattern,

FIG. 7 the detail B in FIG. 6 on a much larger scale,

FIG. 8 a wrapping for packagings, namely a film with a further design of a random pattern,

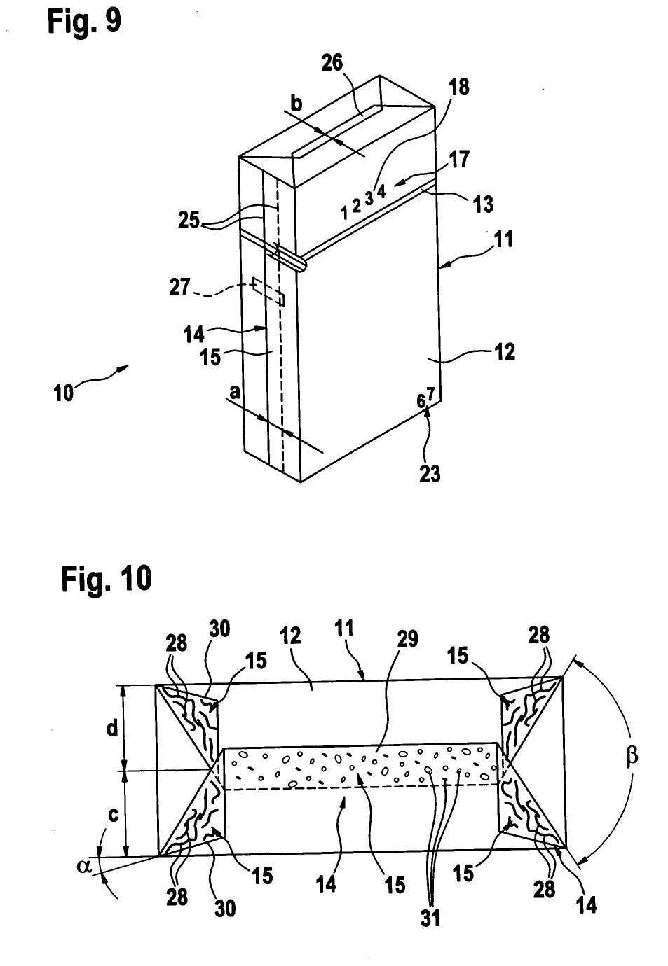

FIG. 9 a perspective view of a packaging with a further design of a random pattern as well as a serial number and a marking,

FIG. 10 a top view of a packaging with a further design of a random pattern,

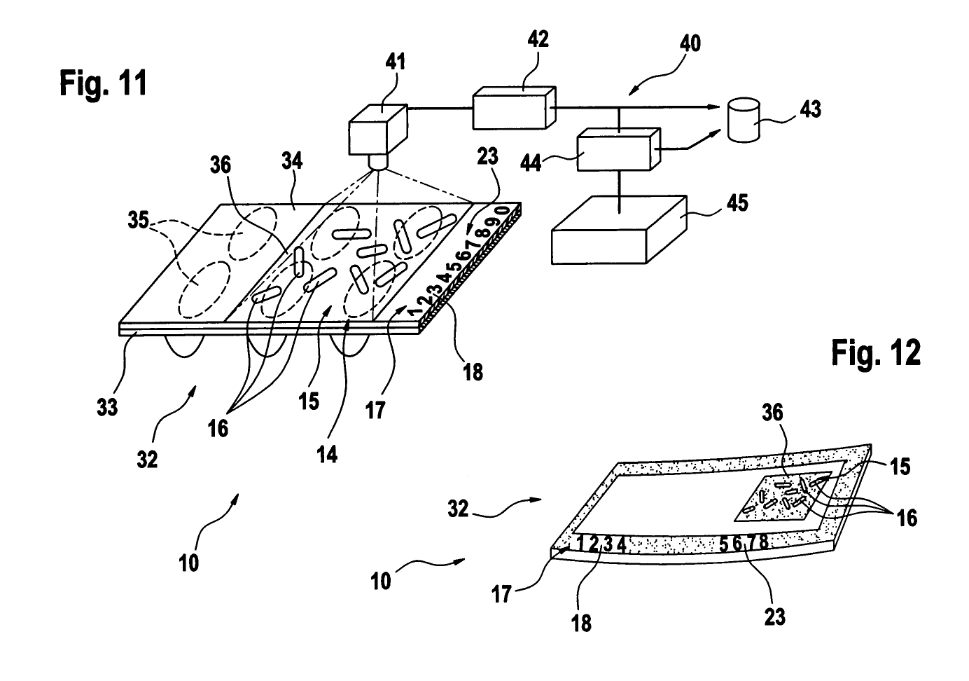

FIG. 11 a further packaging, namely a primary packaging, e.g. for drugs or the like, with a device for marking and identifying the packaging,

FIG. 12 a further primary packaging, namely a sachet,

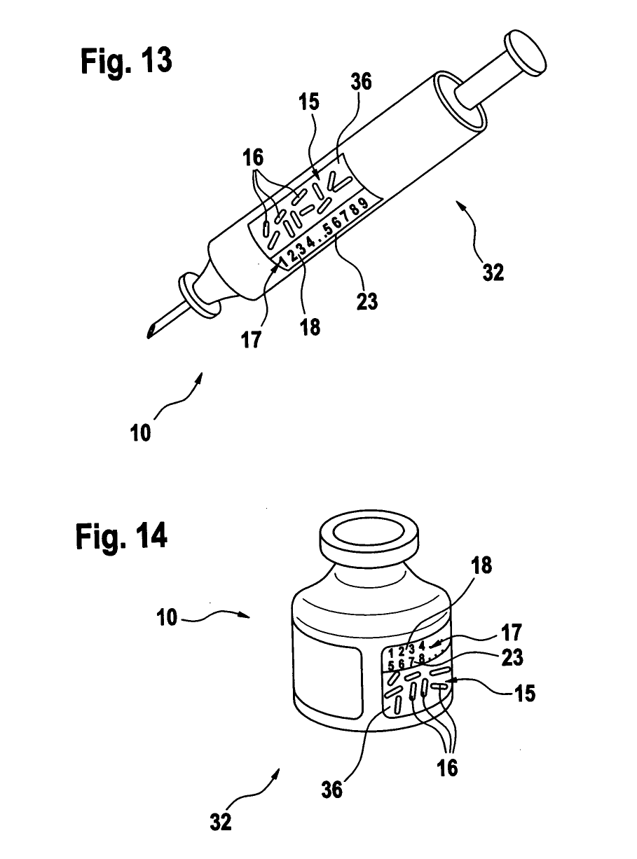

FIG. 13 a further primary packaging, namely a syringe,

FIG. 14 a further primary packaging, namely a small bottle or the like, and

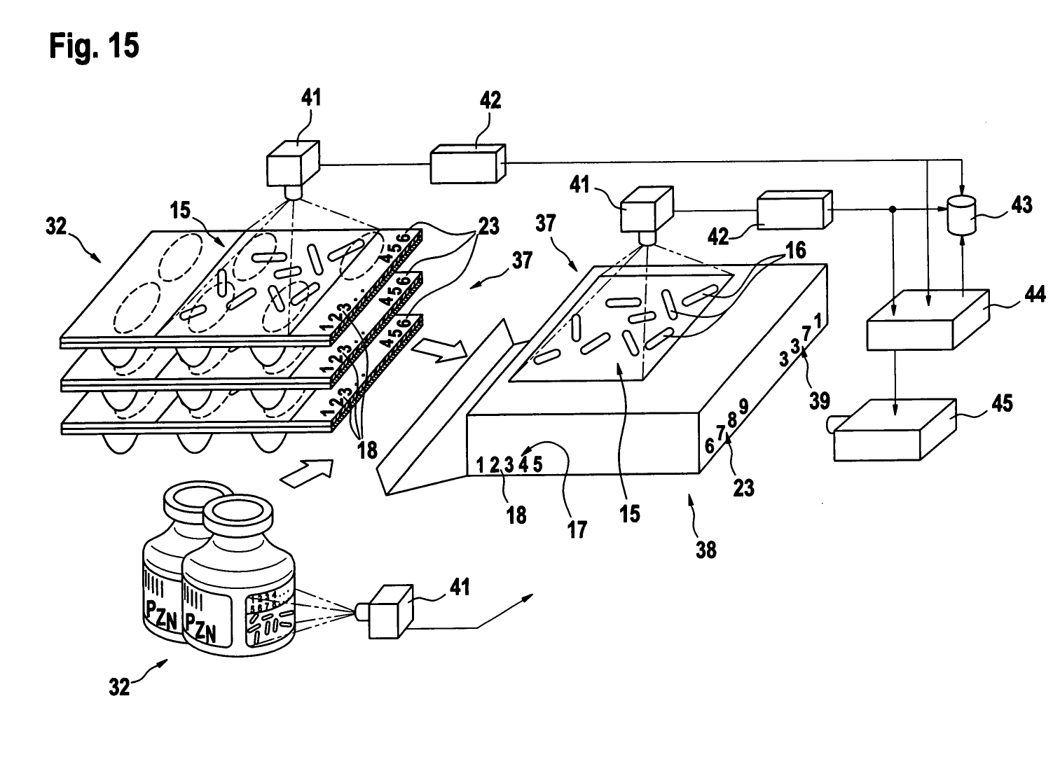

FIG. 15 a packing unit consisting of primary packaging and secondary packaging with a device for marking and identifying the packing unit.

All the packagings shown are designed to ensure exact identification of the packaging. Packagings for cigarettes and solid, liquid and powdered drugs are shown as examples. The invention does however relate to all kinds of packaging in different fields of application, but in particular to packaging in which high-value and particularly often and extensively counterfeited or manipulated products are packed, e.g. packaging for electronic components or cosmetic products. The invention is of course applicable to other articles, e.g. labels, documents or to products such as spare parts as well.

In FIG. 1 is shown a package 10 for cigarettes or the like, which is composed of a folded box 11 and a wrapping 12 surrounding the folded box 11. In the original state of the package 10, that is, in the filled and closed state, the wrapping 12 is provided with a tear strip 13 which is usually separated and destroyed upon opening the package 10. The package 10 is provided with a marking means 14. The marking means 14 is a random identifier 15 which is peculiar to the package 10 and which is arranged in a region of the package 10. Alternatively, several regions or the whole package 10 can be provided with the random identifier 15.

In the embodiment in FIG. 1, the random identifier 15 is a random pattern which is arranged in a corner region of the package 10. The random pattern is composed of a distribution of luminophores 16. Such luminophores 16 are to be rendered visible by irradiation with light from the ultraviolet spectral range (UV light). But the random pattern can also be composed of a distribution of other particles. The random pattern is arranged on the package 10, namely on the folded box 11, so as to be visible or recognisable from the outside. The luminophores 16 can be mixed as particles, pigments or filaments into the fibres of the folded box 11 which is made of cardboard or the like. The position of each random pattern is preferably arranged so as to be readily accessible to measuring means, detection means and the like, this being on the front of the package 10. Any other position on the reverse side, or the side or end surfaces, is also possible.

The random identifier 15 can also be arranged in the region of the tear strip 13. The tear strip 13 in FIG. 2, as an information carrier for holding the random identifier 15 which is in turn a random pattern composed of a distribution of luminophores, is additionally provided with a coding means 17, particularly a serial number 18. Further, the tear strip 13 carries a bar code 19 and reference marks 20. The reference marks 20 serve for easier detection of the position of the luminophores 16. The position of the luminophores 16 can be detected e.g. by distances X and Y in relation to the reference marks 20 as well as the length Z of a luminophore 16 and the angle (p. Other measurable variables, distances, angles or the like can however also be used to detect the random pattern composed of the luminophores 16.

In a further embodiment, the random identifier 15 is arranged on the wrapping 12. The wrapping 12 is usually composed of a film 21 which is usually stored in a roll and is permeated with statistically distributed luminophores 16. The density of the luminophores 16 can vary, but a density of about 20 luminophore particles per 100 cm² is preferred. The film 21 can also be sprinkled with luminophores 16, preferably with a density of about 20-50 luminophore flecks per 100 cm².

In the embodiment in FIG. 4, the random identifier 15 is applied to a label 22. Preferably, the label 22 is designed in colour and carries a random distribution of luminophores 16. The label 22 can be applied between folded box 11 and wrapping 12 or from the outside on the wrapping 12. In addition, the package 10 shown is provided with a serial number 18. The serial number 18 can firstly be designed as ordinary print with ink or the like (FIG. 5, upper serial number). Alternatively the serial number 18 itself can also serve as the carrier of an alternative or supplementary random identifier 15 (FIG. 5, lower serial number). Hence there is the option of providing a package 10 with more than one random identifier 15 or several random patterns.

The serial number 18 can have a distribution of luminophores 16 in the ink or the like. For this purpose the luminophores are contained as an immiscible additive in the ink or the like. The distribution of luminophores 16 is in this case confined exclusively to the region printed with the ink or the like. In a variant which is not shown, however, the luminophores 16 can be arranged in the region of the serial number 18, in such a way that the luminophores 16 are arranged adjacent, above, below, between or on the individual characters of the serial number 18.

The package 10 in FIG. 4 is further provided with a marking 23. The marking 23 can be generated from the distribution of luminophores 16, this being preferably by means of mathematical algorithms, by ordinary cryptological methods or the like. The marking 23 is the result of calculation of the distribution of luminophores 16 and optionally arranged in coded or uncoded form on the package 10. In the embodiment shown, the marking 23 is an uncoded sequence of digits. The marking 23 may however also be composed of letters, picture components, other characters or a combination thereof.

A further embodiment of the package 10 has a stamp 24, in particular a tax stamp. The stamp 24 is the carrier of the random identifier 15, by the fact that the distribution of luminophores 16 is randomly applied to the stamp 24. The position of the luminophores 16 can be determined with the aid of predefined parameters, e.g. X and Y and angle φ, relative to a corresponding system of coordinates (see FIG. 7).

The random identifier 15, namely the random pattern, can also be a measurable variable which is caused by manufacture of the package 10 and respectively characteristic of the package 10. In FIG. 9, for example, the random pattern is a side seam 25 of the wrapping 12. The wrapping 12 overlaps itself, forming the side seam 25. This random pattern arises directly during manufacture and defines the package 10 unambiguously. With the aid of parameters, e.g. the width a of the side seam 25 or the width b of an end seam 26, but also other distances, angles or the like can be used for detection of the random pattern. A scanning mark 27 which is preferably arranged under the wrapping 12 in the region of the side seam 25 is provided for easier detection of the random pattern.

The random pattern can however also be a gap width in the region of the hinged lid of the package 10 or the detection of cut edges e.g. by means of parameters c and d as well as angles α and β (see e.g. FIG. 10). In FIG. 10 are also shown random patterns in the form of wave patterns 28 or contact surfaces 29 at junctions of the wrapping 12. The wave patterns 28 e.g. arise in the region of folds 30 and are unique to each package 10, so that the arrangement and design of the wave patterns 28 can be recognised and optionally also converted to a marking 23. The same applies to the contact surface 29 which has air bubbles 31 or the like in its region. The position, number and distribution of air bubbles 31 is specific to the package and can be recognised from the outside as a random pattern.

Of the security means described above for marking and identifying the package 10, namely the random identifier 15, the coding means 17 and the marking 23, at least two are in correlation with each other. Preferably, the coding means 17 is in a predetermined, reproducible relationship to the marking means 14 or to the random identifier 15. But other reciprocal relationships can be produced too. The correlation can be formed e.g. by storage and/or by a coding function. The storage can be formed as print on the package 10 or in an external data bank.

The package 10 described above is constructed essentially in two parts, namely folded box 11 and wrapping 12. But single-part or multi-part packages too, or completely different articles, e.g. documents, labels, spare parts, can be provided with the individual marking means 14, in particular the random identifier 15, as well as the coding means 17 and the marking 23. Below, other types of packaging are described too, to which basically the principle already described for the above-mentioned packages 10 applies with respect to marking and identification.

In FIGS. 11 to 14, for example packages 10 which are designed as primary packaging 32 are shown. The primary packaging 32, which is in direct contact with the packed product, can be e.g. a blister pack for solid substances, in particular drugs (FIG. 11), a sachet for powdered or liquid substances (FIG. 12), or a syringe or small bottle, flask, vial, carpule or the like for liquid substances (FIGS. 13 and 14). All the embodiments shown in FIGS. 11 to 14 are provided with the random identifier 15, the coding means 17 and the marking 23. Alternatively, however, it is also possible to provide the individual primary packaging 32 with only one of the security means.

The blister pack in FIG. 11 includes a carrier 33 for the products, preferably composed of thermofilm, as well as a cover film 34 for closing the carrier 33 which is provided with nests 35 for holding the products. Preferably, a random pattern of luminophores 16 is applied directly to the cover film 34 as a random identifier 15. The distribution of luminophores 16 is limited to a pattern area of the primary packaging 32. But alternatively it is also conceivable to expand the distribution over the whole primary packaging 32. The luminophores 16 can also be applied to a label 36, wherein the label 36 can optionally be made self-destructive. Preferably in the edge region of the blister pack are arranged the serial number 18 as a coding means 17 as well as the marking 23 which is generated from the random pattern. The other primary packagings 32 shown in FIGS. 12 to 14 are designed or labelled correspondingly. The primary packagings 32 can, apart from drugs, also be designed for other products, e.g. cosmetics, electronic components and others.

In FIG. 15 is shown a packing unit 37 which is composed of several primary packagings 32 and a secondary packaging 38. The primary packagings 32 are designed as described above, wherein each primary packaging 32 has its own coding means 17 or a serial number 18 which carries e.g. all the production data as well as a marking 23 which depends on the random identifier 15 and on the distribution of luminophores 16 as a random pattern. One or more of the primary packagings 32, regardless of whether they are blister packs, flasks or the like, are arranged in their labelled form in the secondary packaging 38. The secondary packaging 38 is a folded box of cardboard or the like in the embodiment shown. Any other surrounding packaging of the usual packing materials is, however, also possible.

The marking of the primary packagings 32, that is, the random identifier 15 and/or the coding means 17 and/or the marking 23, is in correlation with the marking of the secondary packaging 38. Preferably, the secondary packaging 38 has a serial number 18 and a marking 23, wherein the marking 23 is designed as a so-called link number 39. The link number 39 is generated from the serial numbers 18 and/or markings 23 of the primary packagings 32, and so produces an unique relationship between primary packagings 32 and secondary packaging 38.

One or more secondary packagings 38 can further be arranged in or on a tertiary packaging (not shown). The tertiary packaging can be a wrapping, a surrounding carton, a dispatch carton, a transport or display pallet or the like. The tertiary packaging can in turn alternatively or cumulatively be provided with marking consisting of random identifier 15 and/or coding means 17 and/or marking 23, wherein the marking of the tertiary packaging is correlated with the marking of the primary packaging 32 and/or secondary packaging 38.

FIGS. 11 and 15 further show devices 40 for marking and identifying the packages 10 or primary and secondary packagings 32 and 38. The devices 40 for marking and identification are essentially constructed similarly. Ideally, a device 40 for marking the pack 10 (also includes the primary pack 32 and secondary pack 38) is not necessary at all in the actual sense, as the packages 10 themselves or parts of them constitute the marking means 14. However, in order to be able to ensure later identification of the package 10, at least one specific item of information on the package 10 must be included. In a very simple embodiment, not shown, the device 40 for marking the package 10 can be constructed only from a means for detecting at least one random pattern of the package 10, a means for generating and displaying or outputting the marking 23 from the random pattern, and a means for filing the marking 23. Hence in a first step simple marking of the package 10 can be effected, which allows subsequent unambiguous identification. The corresponding device 40 for identification lacks only the means for filing the marking 23. Otherwise the necessary means are the same.

The preferred device 40 for the marking of articles of all kinds, in particular packages 10, essentially includes a means (not shown) for applying the random identifier 15 by a random distribution of luminophores 16. In the event that the random identifier 15 has already been applied off-line in the process of manufacture of the materials required for the package 10, e.g. during manufacture of the cardboard for folded boxes 11 or the film 21, the above-mentioned means, not shown, is dispensable. Furthermore, a camera or the like is provided as the means 41 for detecting the random identifier 15. The camera is connected to the means 42 for generating, namely evaluating the detected data for forming the marking 23 and for compressing the marking 23. Furthermore, the device 40 includes a data bank 43 as a storage medium for filing the evaluated and compressed marking 23 of the random identifier 15. The data bank 43 also serves to store the coding means 17 or serial number 18 previously applied to the package 10. In the data bank 43 the marking 23 of the random identifier 15 is associated with the corresponding serial number 18 to form a unique data pair. The markings 23 on the package 10 and in the data bank 43, which can be generated in each case from the same random pattern, but with different precision, can have a different data record length.

The means 42 is designed to generate the marking 23 from the random identifier 15 and has suitable algorithms for this. Connected to the means 42 is a further means 44 which is designed for cryptology of the marking 23, that is, coding and decoding. The means 44 is connected to a printer 45 or the like, so that the coded or uncoded marking 23 can be applied to the package 10. With the printer 45, for example the serial number 18 can also be applied to the package 10. But the serial number 18 can alternatively be applied by a separate means. All means 41 to 45 of the device 40 are linked together, so that automated marking of the packages 10 by machine is ensured.

The device 40 for identifying the package 10 essentially corresponds to the device 40 for marking the package 10. There is provided at least the means 41 for detecting at least one random identifier 15 peculiar to the package 10, and a means 42 for generating and displaying or outputting the marking 23 from the random identifier 15. The means 41 is designed to emit UV light and pick up the information which has been made visible. Alternatively, however, a design for the emission of IR light or light of other wavelengths also in the visible or invisible range is possible too. The means 42 is further designed additionally for detecting further information located on the package 10, in particular the marking 23 and the serial number 18. The individual items of information can however also be detected by separate means, preferably cameras. The means 42 is designed to carry out mathematical functions in such a way that the random identifier 15 can be converted to the marking 23. In addition, the means 44 for decoding the marking 23 is provided. For alignment of the information picked up and generated with the means 41, 42, 44, the latter are connected to the data bank 43 in order to be able to make a comparison with the information filed there. All the means 41 to 44 are operatively connected to each other by linking them together. Without linking, the device 40 is designed as a mobile hand-held device, wherein the means 41, 42, 44 are accommodated in a common unit.

Below, the methods for marking and identification are described in more detail. The packagings 10, 32, 38 are provided with an individual random pattern. The random pattern, preferably a distribution of luminophores 16, is applied over the whole packaging 10, 32, 38 or in a pattern area. Application can be off-line or preferably on-line. On-line application is effected e.g. by direct printing on the folded box 11, the wrapping 12, the carrier 33 or the cover film 34. Labels 22, 36 can be printed too. Here, the luminophores 16 are for example mixed into the printing ink. The luminophores 16 can however also be introduced into the materials for the packaging 10, 32, 38 already during manufacture of the materials.

Furthermore, a unique serial number 18 is printed on the packaging 10, 32, 38. The serial number 18 is filed in the data bank 43 for each package 10. The pack-specific random pattern is detected by the means 41, evaluated and compressed by the means 42, and also filed in the data bank 43. In the data bank 43, each serial number 18 of a packaging 10, 32, 38 is associated with the compressed random pattern. Alternatively or cumulatively, a marking 23 of each packaging 10, 32, 38, generated from the random pattern, is also filed in the data bank 43 or printed with the printer 45 on the packaging 10, 32, 38. The marking 23 can further be coded by the means 44 before printing or before filing.

Identification takes place virtually in the same way. For identification of the packagings 10, 32, 38, the random pattern is detected. This is done e.g. by a hand-held device which on the one hand is designed to emit UV light or light of another wavelength in order to render the luminophores 16 visible, and secondly serves to pick up the distribution of luminophores 16. By means of suitable algorithms, the marking 23 is determined. The data obtained, namely the marking 23 determined from the random pattern, as well as the serial number 18 are then compared with the data records deposited on the packaging 10, 32, 38 or filed in the data bank 43. In case of an adequate or high correlation, or ideally matching, of the data records, it can be reliably assumed that it is an original packaging. The correlation in this case is a measure of the security of detection. Upon compression of the data records, information is lost. As a result, only a similarity (=correlation) of the data records can be determined. So-called “uncertain evaluation” is then spoken of. The attainable accuracy depends on the data record length, i.e. the longer the marking 23, the higher the degree of security.

In further embodiments which are not described in detail but which can also be used preferably, it is for example possible to generate from the random pattern two or more markings 23 which have different data record lengths. A shorter marking 23 is applied directly to the package 10, while the longer marking 23, which may be almost any length, is filed in the data bank 43. Microscopically small patterns of distributions of particles, luminophores or the like or also fibres of the package 10 itself can also be detected and evaluated as a random pattern.

In marking and identification of the packing unit 37, there are various options. In a first example, the means 41 picks up the data, patterns or the like from the three individual primary packagings 32, generates a common link number 39 therefrom, codes the link number 39 with the means 44, and applies the link number 39 to the secondary packaging 38. Furthermore, the serial number 18 is applied to the secondary packaging 38. With the means 41, furthermore, the data, patterns or the like are picked up from the secondary packaging 38, and with the means 42 the marking 23 is generated and after coding with the means 44 applied to the secondary packaging 38.

Alternatively or cumulatively, all the data, patterns, information, etc. detected, generated and coded can also be filed in the data bank 43 and associated with each other as belonging to the packaging.

For identification, the data, patterns, information, etc. of the secondary packaging 38 are picked up, and the marking 23 is generated and decoded and compared with the marking 23 previously deposited on the secondary packaging 38 or filed in the data bank 43. Association with the serial number 18 increases the security. To check the association of the primary packagings 32 located in the secondary packaging 38, the data, patterns, information, etc. of the secondary packs 32 are detected, generated and decoded and aligned with the link number 39.

1. Article which is provided with an individual marking means for identification, characterised in that the marking means is a random identifier peculiar to the article.

2. Article according to claim 1, characterised in that the article is a package.

3. Article according to claim 1, characterised in that the random identifier forms part of the design of the package.

4. Article according to claim 1, characterised in that the random identifier is composed of at least one random pattern.

5. Article according to claim 4, characterised in that the random pattern is composed of a distribution of luminophores.

6. Article according to claim 4, characterised in that in addition to the random pattern a marking generated from the random pattern is arranged on the package.

7. Article according to claim 5, characterised in that the distribution is detectable and can be filed or deposited as an optionally coded or uncoded marking in a data bank and/or as print on the package.

8. Article according to claim 7, characterised in that, in addition to the random pattern and/or marking, a coding means, in particular a serial number, is applied.

9. Article according to claim 8, characterised in that the coding means is in a predetermined and reproducible relationship to the marking means.

10. Article according to claim 8, characterised in that the coding means and the marking means are in correlation with each other.

11. Article according to claim 10, characterised in that the correlation is formed by storage.

12. Article according to claim 10, characterised in that the correlation is formed by a coding function.

13. Article according to claim 1, characterised in that the random identifier is an integral part of the package itself.

14. Article according to claim 1, characterised in that the random identifier is optionally arranged on the whole package or in a predefined region of the package.

15. Article according to claim 1, characterised in that the package is composed of a primary packaging and/or a secondary packaging and/or a tertiary packaging.

16. Article according to claim 15, characterised in that the coding means and/or the marking means and/or the marking are arranged on the primary packaging and/or the secondary packaging and/or the tertiary packaging in such a way that they can be clearly identified from the outside.

17. Article according to claim 16, characterised in that the marking at least on the secondary packaging is designed as a link number, wherein the link number can be generated from the coding means, and/or the marking means and/or the marking of the primary packaging.

18. Article according to claim 3, characterised in that the random pattern is a gap width and/or an overlap region and/or a contact region of joint surfaces and/or a joint seam and/or a wave pattern of a joint seam and/or folds and/or cut edges or the like of the packaging.

19. Method for the individual marking of articles, in particular packages, with an individual marking means, characterised by the steps of:
detection of a random identifier peculiar to the article, in particular to the package, as a marking means,
conversion of the random identifier to an individual marking, and
filing of the marking as a data record in a data bank and/or deposition as print on the article, in particular on the package.

20. Method according to claim 19, characterised in that a packaging is labelled, wherein the package is provided with a random identifier peculiar to the package, preferably a random pattern consisting of luminophores, as a marking means.

21. Method according to claim 19, characterised in that conversion is effected by means of a suitable mathematical function.

22. Method according to claim 19, characterised in that the marking is coded before printing on the package or before filing in the data bank.

23. Method according to claim 19, characterised in that the marking is compressed before filing in the data bank.

24. Method according to claim 19, characterised in that the random identifier is detected optically.

25. Method according to claim 19, characterised in that the random distribution of luminophores is made visible with UV light, coded numerically and stored as the random identifier.

26. Method according to claim 19, characterised in that the package is additionally provided with an individual coding means, in particular a serial number.

27. Method according to claim 26, characterised in that at least the marking means and the coding means are combined into a data pair and put in a predetermined, reproducible reference relationship to each other.

28. Method according to claim 27, characterised in that the data pairs are in each case correlated with each other and filed in a data bank.

29. Method according to claim 26, characterised in that provision of the package with the coding means and/or the marking means and/or the marking takes place optionally on-line or off-line.

30. Method according to claim 26, characterised in that the marking means, the coding means and the marking are optionally applied to a primary packaging and/or a secondary packaging and/or a tertiary packaging or attached to one of them.

31. Method for the identification of articles, in particular packages, which are provided with an individual marking means, by detection and evaluation of the marking means, characterised by the steps of:
detection of a random identifier peculiar to the article, in particular to the package, as a marking means,
conversion of the random identifier to an individual marking, and
alignment of the marking with print of the marking on the article, in particular on the package, and/or a data record filed in a data bank and containing the marking.

32. Method according to claim 31, characterised in that the random identifier is rendered visible by irradiation with light in the ultraviolet spectral range and detected optically.

33. Method according to claim 31, characterised in that conversion is effected by means of a suitable mathematical function.

34. Method according to claim 31, characterised in that the random identifier is scanned, wherein the associated marking is determined from the scanned information and compared with print applied to the package and/or a data record filed in a data bank.

35. Method according to claim 31, characterised in that in addition a coding means arranged on the package, in particular a serial number, is detected.

36. Method according to claim 35, characterised in that a data pair which is composed of coding means and marking means and which is formed from the information detected is compared with a data pair filed in the data bank.

37. Device for the individual marking of articles, in particular packages, with an individual marking means, characterised in that a means is provided for detecting at least one random identifier peculiar to the article, in particular to the package, as a marking means, a means for generating and displaying or outputting a marking from the random identifier, and a means for filing or depositing the marking.

38. Device according to claim 37, characterised in that in addition a means for applying the random identifier is provided.

39. Device according to claim 37, characterised in that the means for deposition or filing includes a printer or the like and/or a storage means, in particular a data bank.

40. Device according to claim 39, characterised in that in addition a means for applying a coding means is provided, wherein the means for applying the coding means can be identical with the printer for depositing the marking.

41. Device according to claim 40, characterised in that in addition means are provided for coding the marking.

42. Device according to claim 41, characterised in that the means for detecting at least one random identifier, the means for generating and displaying or outputting a marking, the storage means, the means for coding and the means for depositing or filing are operatively connected to each other, and are preferably linked together.

43. Device for the identification of articles, in particular packages, provided with an individual marking means, characterised in that a means is provided for detecting at least one random identifier peculiar to the article, in particular to the package, as a marking means, and a means for generating and displaying or outputting a marking from the random identifier.

44. Device according to claim 43, characterised in that the means for detecting is designed to emit UV light and pick up the information which is rendered visible.

45. Device according to claim 43, characterised in that in addition the means for detecting is designed to detect further information located on the package, in particular the marking and a coding means.

46. Device according to claim 43, characterised in that the means for generating and displaying or outputting is designed to carry out mathematical functions, in such a way that the random identifier can be converted to the marking.

47. Device according to claim 43, characterised in that in addition a means is provided for decoding the marking.

48. Device according to claim 47, characterised in that the means for detecting, the means for generating and displaying or outputting and the means for decoding are connected to a storage means, in particular a data bank.

49. Device according to claims 48, characterised in that the means for detecting, the means for generating and displaying or outputting, the storage means and the means for decoding are operatively connected to each other, and are preferably linked together.

50. Device according to claim 43, characterised in that the device is designed as a mobile hand-held device.
